(19) United States
(12) Patent Application Publication
(10) Pub. No.: US 2019/0243796 A1
(43) Pub. Date: Aug. 8, 2019

(54) DATA STORAGE MODULE AND MODULAR STORAGE SYSTEM INCLUDING ONE OR MORE DATA STORAGE MODULES

(71) Applicant: Samsung Electronics Co., Ltd., Suwon-si (KR)

(72) Inventor: Zhan Ping, San Jose, CA (US)

(21) Appl. No.: 15/961,583

(22) Filed: Apr. 24, 2018

Related U.S. Application Data
(60) Provisional application No. 62/626,841, filed on Feb. 6, 2018.

(51) Int. Cl. G06F 13/40; G06F 13/16

(52) U.S. Cl. CPC G06F 13/4068; G06F 13/1668; H04L 67/104; G06F 2213/0026; G06F 13/4022

(57) ABSTRACT

A data storage module includes: a circuit chip receiving network packets and translating the network packets received from a host computer to a peripheral component interconnect express (PCIe) packets; a field-programmable grid array (FPGA); and one or more data storage devices storing data received from the host computer over the network packets. The circuit chip is coupled to the FPGA and the one or more data storage devices over a PCIe interface. The FPGA is programmably configured to perform one or more data processing acceleration on the data received from the circuit chip over the PCIe interface.

### CROSS-REFERENCE TO RELATED APPLICATION(S)

This application claims the benefits of and priority to U.S. Provisional Patent Application Ser. No. 62/626,841 filed Feb. 6, 2018, the disclosure of which is incorporated herein by reference in its entirety.

### TECHNICAL FIELD

The present disclosure relates generally to data storage devices, more particularly, to a data storage module and a modular data storage system including one or more data storage modules.

### BACKGROUND

As more and more data are generated from mobile devices, the amount of data transfer from those mobile devices to a datacenter dramatically increases year by year. An edge device such as a switch or a router that provides an entry point into an enterprise or service network can pre-process data generated by mobile devices to offload the workload at the datacenter and make the data transfer more efficient and cost-effective. However, the data pre-processing in the edge device requires a high-density and high-performance data storage.

Solid-state drives (SSDs) such as all-flash arrays that includes multiple flash memory drives are rapidly becoming main storage elements of modern datacenter infrastructure quickly replacing traditional storage devices such as hard disk drives (HDDs). SSDs offer low latency, high data read/write throughput, and reliable persistent storage of user data. Non-volatile memory express (NVMe) over fabrics (NVMe-oF) is an emerging technology that allows hundreds and thousands of SSDs to be connected over a fabric network such as Ethernet, Fibre Channel, and InfiniBand.

The NVMe-oF protocol enables communication between a host computer and a storage system over the fabric network using remote direct memory access (RDMA). The NVMe-oF protocol can use any of the RDMA technologies, including InfiniBand, RoCE and iWARP. The NVMe-oF protocol has a low latency, for example, adding just a few microseconds to cross the fabric network, making a remote storage virtually indistinguishable from a local storage. As any network protocol, the NVMe-oF protocol can be used to access a simple feature-less storage box, often referred to as just bunch of flash (JBOF), as well as a feature-rich block storage system used in a storage-area network (SAN).

Currently, NVMe-oF-compatible SSDs (or JBOF storage boxes) are increasingly used in a system architecture to include a network interface card (NIC), a central processing unit (CPU), and a flash disk. However, those NVMe-oF-compatible SSDs do not have sufficient local data processing capability.

### SUMMARY

According to one embodiment, a data storage module includes: a circuit chip receiving network packets and translating the network packets received from a host computer to a peripheral component interconnect express (PCIe) packets; a field-programmable grid array (FPGA); and one or more data storage devices storing data received from the host computer over the network packets. The circuit chip is coupled to the FPGA and the one or more data storage devices over a PCIe interface. The FPGA is programmably configured to perform one or more data processing acceleration on the data received from the circuit chip over the PCIe interface.

According to another embodiment, a data storage system includes: one or more data storage modules; and a baseboard coupling the one or more data storage modules. At least one of the one or more data storage modules includes: a circuit chip receiving network packets and translating the network packets received from a host computer to a peripheral component interconnect express (PCIe) packets; a field-programmable grid array (FPGA); and one or more data storage devices storing data received from the host computer over the network packets. The circuit chip is coupled to the FPGA and the one or more data storage devices over a PCIe interface. The FPGA is programmably configured to perform one or more data processing acceleration on the data received from the circuit chip over the PCIe interface. The FPGA is coupled to is connected to a second FPGA of another data storage module among the one or more data storage modules included in the data storage system over a high-speed interlink for peer-to-peer communication.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 shows a block diagram of an example base storage module, according to one embodiment;

FIG. 2 shows a block diagram of an example base storage module including an FPGA with acceleration features, according to one embodiment; and

FIG. 3 shows a block diagram of an example data storage system including a plurality of base storage modules, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a data storage module and a modular data storage system including one or more data storage modules. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present disclosure describes a storage solution to satisfy a need for edge computing. Edge computing herein refers to a capability of an edge device to pre-process local data generated by mobile devices or offloading workloads from a remote cloud to a base station etc. An edge device includes a router, a routing switch, a switch, an integrated access device, a multiplexer, and a variety of metropolitan area network (MAN) and wide area network (WAN) access points that provide entry points into an enterprise or service provider core networks. An edge device may translate between one type of network protocol and another protocol. In general, edge devices provide access to faster, more efficient backbone and core networks. An edge device may also provide enhanced services, such as VPN support, VoIP, and Quality of Service (QoS). An edge device may or may not modify the traffic it receives, depending on the function of the edge device and the communication protocol(s) of the incoming and outgoing traffic. For example, a simple switch routes the incoming traffic without making any modifications to the incoming packets, whereas an edge device, for example, a session border controller, may do some data conversions on the incoming packets before sending the modified packets.

The present disclosure provides a high-density and high-performance NVMe-oF storage module and an NVMe-oF based modular storage system that includes one or more NVMe-oF storage modules. Herein, the term “module,” may refer to a device, a sub-system, or the like, and those terms may be interchangeably used without deviating from the scope of the present disclosure.

The NVMe-oF protocol provides a transport-mapping mechanism for exchanging commands and responses between a host computer and a target storage device over a fabric network such as Ethernet, Fibre Channel, and InfiniBand using a message-based model. Each of the NVMe-oF storage modules can contain a system-on-chip (SOC) (e.g., an application-specific integrated circuit (ASIC)) to convert Ethernet packets to NVMe (or Peripheral Component Interconnect Express (PCIe)) packets and a field programmable gate array (FPGA) to perform storage data processing acceleration. For example, the NVMe-oF storage module can contain a high-speed interlink enabling peer-to-peer communication with other NVMe-oF storage modules in the same chassis. The NVMe-oF storage module can be used individually or collectively in a data storage system that is capable of data processing acceleration near the storage or within the storage. Alternatively, the present modular storage system can include several NVMe-oF storage modules in a standard server chassis (e.g., 1 U or 2 U chassis) to scale the capacity and performance depending on the need and requirements of a target application and/or the type of data stored therein.

The present modular storage system provides high density data storage. In a full-height, half-length (FHHL) form factor, each NVMe-oF storage module can have a 64 TB storage capacity. In one embodiment, the present modular storage system includes four NVMe-oF storage modules accommodated in a 1 U chassis, and the total storage capacity of the present modular storage system can reach up to 256 TB. In another embodiment, the present modular storage system can have up to eight NVMe-oF storage modules accommodated in a 2 U chassis, and the total storage capacity of the present modular storage system can reach up to 512 TB.

The present modular storage system can provide high data storage and processing performance. Each NVMe-oF storage module can achieve I/O performance reaching up to 3 million input/output operations per second (MIOPS). The total storage capacity of the present modular storage system including eight NVMe-oF storage modules can achieve the I/O performance reaching up to 24 MIOPS.

The present modular storage system provides flexibility and scalability. A user can utilize one or more NVMe-oF storage modules to easily build up a storage system that fits a customers' needs without redesigning a data storage system. The present modular storage system is also highly reconfigurable. The acceleration feature can be reconfigurable to satisfy various needs and applications from different customers. The present modular storage system has high serviceability. Each storage modules can be plugged in or pulled out separately for reconfiguration or replacements.

The present modular storage system can lower the total cost of ownership (TCO) of a datacenter. The present modular storage system does not require a high-cost CPU to process (or pre-process) data. Instead, each of the data storage module includes a FPGA and a switch to perform the data processing (or pre-processing) near or in storage. This can save not only on the build of materials (BOM) cost of the data storage system but also greatly reduce the power consumption and the cost for thermal control within the data center.

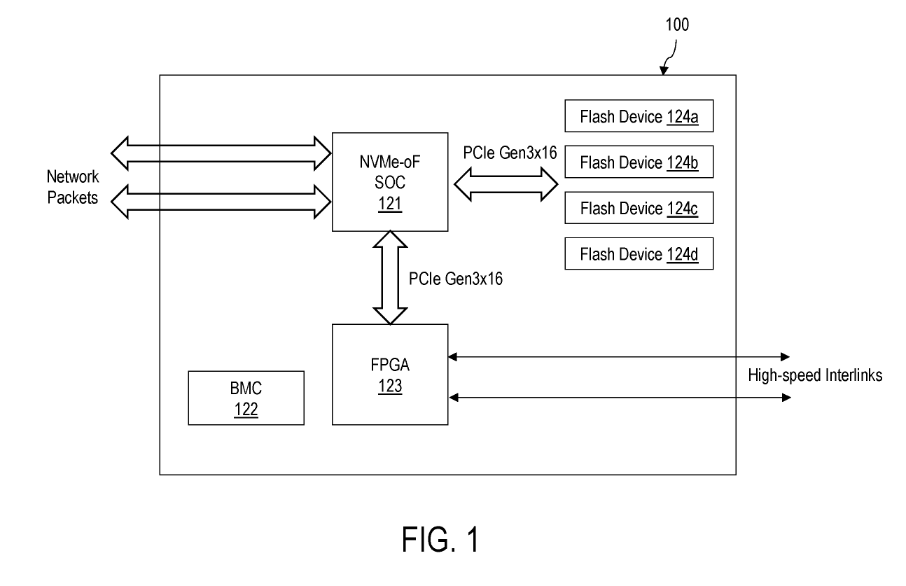

FIG. 1 shows a block diagram of an example base storage module, according to one embodiment. The base storage module 100 includes an NVMe-oF SOC 121, a baseboard management controller (BMC) 122, an FPGA 123, and one or more flash devices 124. The BMC 122 is a service processor that can monitor the physical state of the base storage module 100 using various sensors, for example, a power status sensor (not shown). The BMC 122 can communicate with a service administrator through an independent communication path such as a system management bus (SMBus).

The NVMe-oF SOC 121 provides an NVMe-oF interface for the base storage module 100 to connect to a host computer (not shown) via one or more Ethernet ports. For example, the Ethernet port is a 100 Gigabit Ethernet (Gbe) port, and the base storage module 100 has two 100Gbe ports. The host computer can send Ethernet packets to the base storage module 100 including commands to read, modify, and write data on the flash devices 124. According to one embodiment, the NVMe-oF SOC 121 may be an off-the-shelf chip with a limited computational capability. The flash device 124 included in the base storage module 100 may be a Next Generation Small Form Factor (NGSFF) disk designed and manufactured by Samsung Electronics, Co. Ltd. According to the commands received from the host computer, the NVMe-oF SOC 121 writes data to, reads data from, and modifies data stored in the flash devices 124.

The FPGA 123 is connected to the NVMe-oF SOC 121 via a PCIe port (e.g., PCIe Gen3 X4 root port). The NVMe-oF SOC 121 can send data stored or to be stored in the flash devices 124 to the FPGA 123 via the PCIe port for data processing within the base storage module 100. The FPGA 123 may include one or more of a neural processing unit (NPU), programmable logic gates, and memory blocks (e.g., RAM blocks) that can be programmably configured to accelerate specific data processing features on the data received from the NVMe-oF SOC 121. Examples of the data processing features that can be performed by the FPGA 123 include, but are not limited to, encryption, in-storage data (pre-)processing, or other user-configurable acceleration and/or data processing features. In addition, the FPGA 123 has one or more high-speed interlink connections to another based module that is coupled to the baseboard of the same chassis. The high-speed interlink connections among the FPGAs 123 of a plurality of base storage modules included in a data storage system enables collaborative data processing and acceleration on a large amount of data that may be distributed among the plurality of base storage modules.

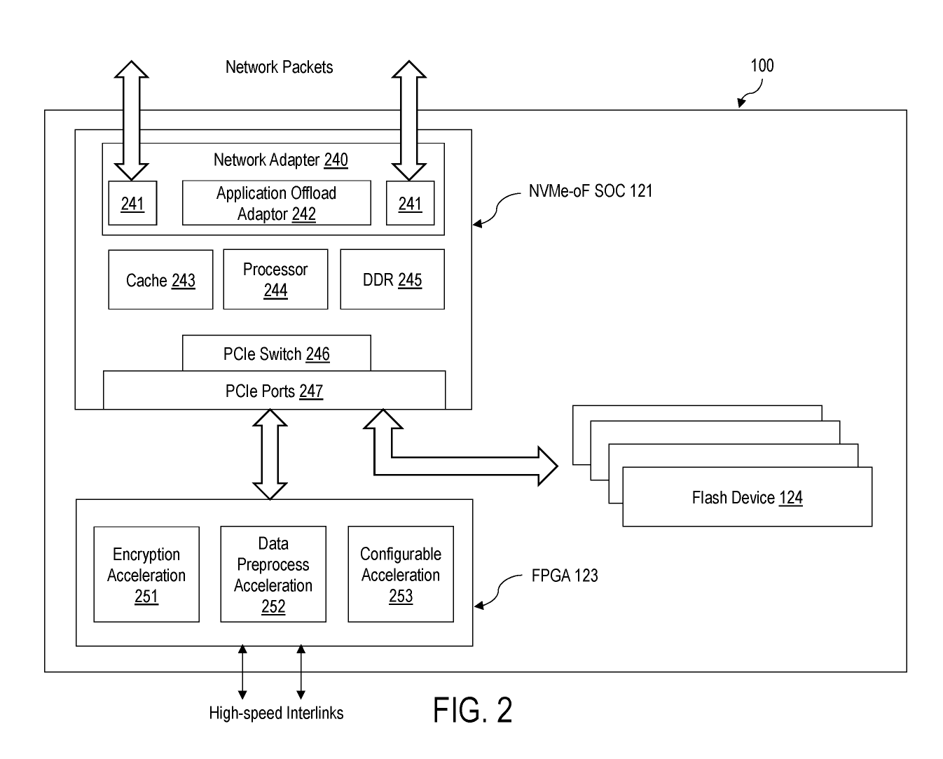

FIG. 2 shows a block diagram of an example base storage module including an FPGA with acceleration features, according to one embodiment. FIG. 2 shows subsystems and functional blocks of the base storage module 100 shown in FIG. 1. For the sake of brevity, portions of the descriptions for the base storage module 100 that have been discussed with respect to the base storage module 100 in FIG. 1 will not be repeated.

The NVMe-oF SOC 121 includes a network adaptor 240, a cache 243, a processor 244, a double data rate (DDR) memory 245, a PCIe switch 246, and a plurality of PCIe ports 247. According to one embodiment, the NVMe-oF SOC 121 is a single chip device that is capable of functioning as a network adaptor, an embedded system tailored for addressing diverse applications including, but not limited to, data storage, security, networking, and machine learning.

The processor 244 may be a multi-core processor including a plurality of processor cores that interconnected to the cache 243, the DDR memory 245, the network adaptor 240, and the PCIe switch 246 by a coherent mesh. The processor cores enable sophisticated applications and advance feature sets in conjunction with other components integrated in the NVMe-oF SOC 121.

The network adaptor 240 can support transportation of network packets at 10/25/40/50/56/100Gigabits per second. According to one embodiment, the network adaptor 240 has a plurality of Virtual Protocol Interconnect (VPI) ports that support InfiniB and or Ethernet connectivity for PCIe Gen3 servers used in enterprise datacenters, high-performance computing, and embedded environments. The integrated PCIe switch 246 can have endpoint and root complex functionality up to 32 lanes of PCIe Gen 3 or Gen 4.

The network adaptor 240 includes one or more packet processors 241 and an application offload adaptor 242. The packet processor 241 is configured to receiving and transmitting network packets over the network fabric. The application offload adaptor 242 can offload workloads for networking and storage applications running on the host computer by performing advanced features such as NVMe-oF that can deliver performance. Examples of the advanced features that the application offload adaptor 242 can perform include, but are not limited to, an embedded virtual switch with programmable access control list (ACL), transport offloads and stateless encapsulation/decapsulation of overlay protocols (e.g., NVGRE, VXLAN, and MPLS).

The FPGA 123 can be configured (or programmed) to implement one or more data acceleration features. Some of the data acceleration features may be prepopulated for a target application. Examples of the data acceleration features include, but are not limited to, an encryption acceleration 251, a data pre-process application 252, and other user-configurable acceleration 253. The FPGA 123 has one or more high-speed interlinks to connect to another FPGA integrated in a different base storage module over a dedicated path.

According to one embodiment, the NVMe-oF SOC 121 connects to the FPGA 123 and the one or more flash devices 124 over a PCIe interface. In the case of PCIe Gen4, the PCIe ports 247 of the NVMe-oF SOC 121 can support up to 16 PCIe ports and 32 PCIe lanes. The 16 PCIe ports and 32 PCIe lanes may be split to communicate with the FPGA 123 and the flash devices 124. For example, the first 8 PCIe port and the corresponding 16 PCIe lanes can be used to communicate with the FPGA 123, and the remaining 8 PCIe ports and the corresponding 16 PCIe lanes can be used to communicate with the flash devices 124.

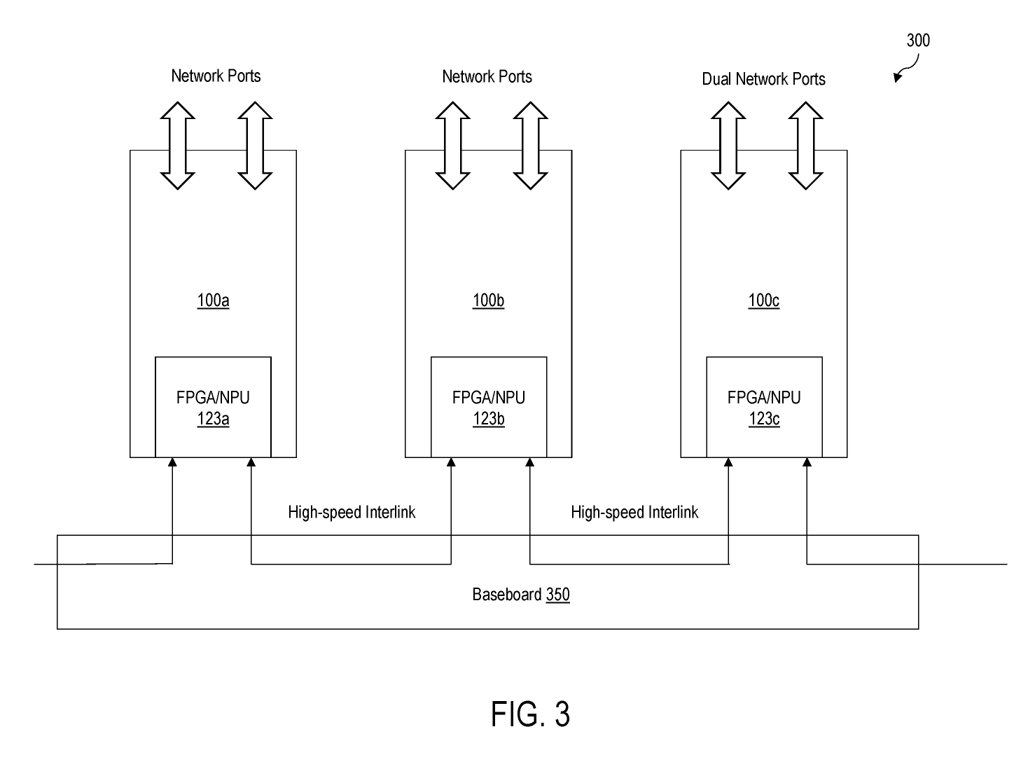

FIG. 3 shows a block diagram of an example data storage system including a plurality of base storage modules, according to one embodiment. The data storage system 300 includes one or more base storage modules 100. In the present example, only three base storage modules 100a, 100b, and 100c are shown, but it is understood that more or less number of base storage modules can be included in the data storage system 300 depending on the form factor and size of the base storage module and the data storage system. For example, the data storage system 300 can have a rack-mountable 1U chassis and includes one to four base storage modules 100. In another example, the data storage system 300 can have a rack-mountable 2U chassis and includes up to eight base storage modules 100 having 512 TB data storage capacity and 24 MIOPS performance. Based on the number of base storage modules 100, the data storage system 300 can be configured to have desired and scaled-out capacity and performance characteristics.

The plurality of base storage modules 100 is connected to each other via a baseboard 350. The baseboard 350 may provide a wired communication path between adjacent FPGAs 123 arranged within each of the based storage modules 100. For example, each FPGA 123 has two high-speed interlinks. One of them is used to communicate with the FPGA of a neighboring base storage module on one side, and the other is used to communicate with the FPGA of another neighboring base storage module on another side. Depending on the capacity of the data storage system 300, the base board 350 can accommodate the base storage modules in a row or multiple rows. The high-speed interlinks may be routed to minimize the communication path between the connected FPGAs 123.

Each base storage module 100 can be plugged in or pulled out separately from the data storage system 300 for reconfiguration or replacements. The base storage module 100 does not include a high-cost CPU to processing the data. Instead, the base storage module 100 includes a programmable FPGA and an NVMe-oF SOC to complete networking and storage tasks. Resultantly, the data storage system 300 can not only save the cost but also greatly reduce the power consumption and thermal dissipation saving the overall cost to operate the data storage system. The data storage system 300 can be used in a datacenter for cloud or enterprise applications.

According to one embodiment, a data storage module includes: a circuit chip receiving network packets and translating the network packets received from a host computer to a peripheral component interconnect express (PCIe) packets; a field-programmable grid array (FPGA); and one or more data storage devices storing data received from the host computer over the network packets. The circuit chip is coupled to the FPGA and the one or more data storage devices over a PCIe interface. The FPGA is programmably configured to perform one or more data processing acceleration on the data received from the circuit chip over the PCIe interface.

The one or more data storage devices may include flash memory devices.

The circuit chip may support transportation of messages between the host computer and the data storage device over a fabric network.

The circuit chip may include a network adaptor providing transportation of the network packets over the fabric network, an application-offload adaptor offloading workloads of an application running on the host computer, and a PCIe switch having a plurality of PCIe ports.

The plurality of PCIe ports may include 16 PCIe ports, and a first group of 8 PCIe ports is used to communicate with the FPGA, and a second group of 8 PCIe ports is used to communicate with the one or more data storage devices.

The FPGA may be connected to a second FPGA of another data storage module over a high-speed interlink for peer-to-peer communication.

The FPGA may include at least one of data encryption acceleration feature, a data pre-process application feature, and a user-configurable acceleration feature.

According to another embodiment, a data storage system includes: one or more data storage modules; and a baseboard coupling the one or more data storage modules. At least one of the one or more data storage modules includes: a circuit chip receiving network packets and translating the network packets received from a host computer to a peripheral component interconnect express (PCIe) packets; a field-programmable grid array (FPGA); and one or more data storage devices storing data received from the host computer over the network packets. The circuit chip is coupled to the FPGA and the one or more data storage devices over a PCIe interface. The FPGA is programmably configured to perform one or more data processing acceleration on the data received from the circuit chip over the PCIe interface. The FPGA is coupled to is connected to a second FPGA of another data storage module among the one or more data storage modules included in the data storage system over a high-speed interlink for peer-to-peer communication.

The one or more data storage devices may include flash memory devices.

The circuit chip may support transportation of messages between the host computer and the data storage device over a fabric network.

The circuit chip may include a network adaptor providing transportation of the network packets over the fabric network, an application-offload adaptor offloading workloads of an application running on the host computer, and a PCIe switch having a plurality of PCIe ports.

The plurality of PCIe ports may include 16 PCIe ports, and a first group of 8 PCIe ports is used to communicate with the FPGA, and a second group of 8 PCIe is used to communicate with the one or more data storage devices.

The FPGA may include at least one of data encryption acceleration feature, a data pre-process application feature, and a user-configurable acceleration feature.

The data storage system may be rack-mountable to a rack system.

At least one of the data storage modules may have a full-height, half-length (FHHL) form factor, 64 TB storage capacity, and 3 million input/output operations per second (MIOPS).

The data storage system may have a 1 U chassis mountable to the rack system and includes four data storage modules arranged in a row.

The data storage system may have 256 TB storage capacity and 12 MIOPS.

The data storage system may have a 2 U chassis mountable to the rack system and includes eight data storage modules arranged in two rows.

The data storage system may have 512 TB storage capacity and 24 MIOPS.

The baseboard may include wires of high-speed interlinks connecting FPGAs of the one or more data storage modules.

The above example embodiments have been described hereinabove to illustrate various embodiments of implementing a system and method for providing a data storage module and a modular data storage system including one or more data storage modules. Various modifications and departures from the disclosed example embodiments will occur to those having ordinary skill in the art. The subject matter that is intended to be within the scope of the invention is set forth in the following claims.

1. A first data storage module comprising:
a circuit chip receiving network packets over a network interface and translating the network packets received from a host computer to a peripheral component interconnect express (PCIe) packets;
a field-programmable grid array (FPGA); and
one or more data storage devices storing data received from the host computer over the network interface,
wherein the circuit chip is coupled to the FPGA and the one or more data storage devices over a PCIe interface and is configured to receive data stored in the one or more data storage devices over the PCIe interface,
wherein the FPGA is programmably configured to perform one or more data processing acceleration on the data that is stored in one or more data storage devices and received from the circuit chip over the PCIe interface,
wherein the FPGA is connected to a second FPGA of a second data storage module over a high-speed interlink for peer-to-peer communication, and
wherein the high-speed interlink is different from the network interface or the PCIe interface.

2. The first data storage module of claim 1, wherein the one or more data storage devices include flash memory devices.

3. The first data storage module of claim 1, wherein the circuit chip supports transportation of messages between the host computer and the data storage device over a fabric network.

4. The first data storage module of claim 3, wherein the circuit chip includes a network adaptor providing transportation of the network packets over the fabric network, an application-offload adaptor offloading workloads of an application running on the host computer, and a PCIe switch having a plurality of PCIe ports.

5. The first data storage module of claim 1, wherein the plurality of PCIe ports include 16 PCIe ports, and a first group of 8 PCIe ports is used to communicate with the FPGA, and a second group of 8 PCIe ports is used to communicate with the one or more data storage devices.

6. (canceled)

7. The first data storage module of claim 1, wherein the FPGA includes at least one of data encryption acceleration feature, a data pre-process application feature, and a user-configurable acceleration feature.

8. A data storage system comprising:
one or more data storage modules; and
a baseboard coupling the one or more data storage modules,
wherein at least one of the one or more data storage modules comprises:
a circuit chip receiving network packets over a network interface and translating the network packets received from a host computer to a peripheral component interconnect express (PCIe) packets;
a field-programmable grid array (FPGA); and
one or more data storage devices storing data received from the host computer over the network interface,
wherein the circuit chip is coupled to the FPGA and the one or more data storage devices over a PCIe interface and is configured to receive data stored in the one or more data storage devices over the PCIe interface,
wherein the FPGA is programmably configured to perform one or more data processing acceleration on the data that is stored in one or more data storage devices and received from the circuit chip over the PCIe interface,
wherein the FPGA is coupled to is connected to a second FPGA of another data storage module among the one or more data storage modules included in the data storage system over a high-speed interlink for peer-to-peer communication, and
wherein the high-speed interlink is different from the network interface or the PCIe interface.

9. The data storage system of claim 8, wherein the one or more data storage devices include flash memory devices.

10. The data storage system of claim 8, wherein the circuit chip supports transportation of messages between the host computer and the data storage device over a fabric network.

11. The data storage system of claim 10, wherein the circuit chip includes a network adaptor providing transportation of the network packets over the fabric network, an application-offload adaptor offloading workloads of an application running on the host computer, and a PCIe switch having a plurality of PCIe ports.

12. The data storage system of claim 8, wherein the plurality of PCIe ports includes 16 PCIe ports, and a first group of 8 PCIe ports is used to communicate with the FPGA, and a second group of 8 PCIe ports is used to communicate with the one or more data storage devices.

13. The data storage system of claim 8, wherein the FPGA includes at least one of data encryption acceleration feature, a data pre-process application feature, and a user-configurable acceleration feature.

14. The data storage system of claim 8, wherein the data storage system is rack-mountable to a rack system.

15. The data storage system of claim 8, wherein at least one of the data storage modules has a full-height, half-length (FHHL) form factor, 64 TB storage capacity, and 3 million input/output operations per second (MIOPS).

16. The data storage system of claim 14, wherein the data storage system has a 1 U chassis mountable to the rack system and includes four data storage modules arranged in a row.

17. The data storage system of claim 16, wherein the data storage system has 256 TB storage capacity and 12 MIOPS.

18. The data storage system of claim 14, wherein the data storage system has a 2 U chassis mountable to the rack system and includes eight data storage modules arranged in two rows.

19. The data storage system of claim 18, wherein the data storage system has 512 TB storage capacity and 24 MIOPS.

20. The data storage system of claim 8, wherein the baseboard includes wires of the high-speed interlinks connecting FPGAs of the one or more data storage modules.
